(19) United States
(12) Patent Application Publication
(10) Pub. No.: US 2004/0039578 A1
(43) Pub. Date: Feb. 26, 2004

(54) Method and system for prompting an individual to provide a more complete specification

(76) Inventor: Joseph A. Sirois, Amherst, NH (US)

Correspondence Address: Robert K. Tendler, 65 Atlantic Avenue, Boston, MA, 02110, US

(21) Appl. No.: 10/174,279

(22) Filed: Jun. 18, 2002

(51) Int. Cl. G06F 17/60

(52) U.S. Cl. 705/1

(57) ABSTRACT

A method is provided to prompt an engineer to more completely specify the product desired so as to minimize misinterpretation and misunderstanding leading to improper design and improper product outcome downstream. In one embodiment, the individual generating the specification is instructed to consider a series of questions that relate to the particular function and its behavior, as well as the end performance characteristics of the final product, also including questions relating to cost, priority of the requirement itself and any internal integration and test functions. In addition to the questions, categories of requirements are also utilized depending on the type of specification to be generated. The result of considering a pre-selected set of questions coupled with a pre-selected set of categories is that a more complete and better understanding of the project from both the product developer and the product specified can be obtained. This method can be utilized both in the generation of the specification and in the analysis of any specification presented to a product developer so that any ambiguities or questions can be identified at the start of the project as opposed to being identified after the project is midway or close to completion.

### FIELD OF INVENTION

This invention relates to methods of prompting individuals to completely address all aspects of a specification and more particularly to a method for identifying the necessary and behavioral characteristics that completely specify the function.

### BACKGROUND OF THE INVENTION

Whenever a given task or project is commenced, a specification defines the product scope to be performed in order to successfully complete the project. While the project may have a result that is to be achieved, just merely specifying the result to be achieved is insufficient to guide the design team to successful completion.

For instance, if a software element on a computer is involved, assuming that the software element is to perform a function, if one does not specify the timeline for achieving the function, the end result may come beyond when necessary for the system to be successful.

For instance, in order for an aircraft to perform evasive measures or to deploy counter measures when illuminated by a radar, if the detection of the illumination or other signals comes too late for the deployment of counter measures, then the function is not performed on a time-line which would permit evasive action or counter measure deployment. In short, if the result comes out too late, the utilization of such a component is rendered useless and need not be on board.

It is therefore necessary in all instances to analyze the behavioral component of the function that is desired in order to be able at least to ascertain whether the function can be completed in a timely manner so as to have the result be meaningful.

While the above example seeks to add to the queries of what is required of the specification, such as, a timeline, there are indeed a number of other categories which need to be considered in order for the product to provide the expected result.

For large systems, be they commercial or military, the design phase of the project is indeed the most critical phase. It is critical at least in the sense that it has the most impact on overall lifecycle cost of the system; or whether or not the system performs at all to a specification. Knowing or being able to quantify what the system should do requires a complete understanding by all of the design team, the characteristics of the system and what it is to do and when.

One type of situation which could perhaps have been remedied during the design phase is the design of the Titanic. As is well known, the Titanic had supposedly secure watertight compartments. The design of these compartments, however, did not take into account that the compartments needed to be sealed at deck level. The compartments were sealed from the bottom of the ship upwardly but were not sealed at the top. The result of not considering “if a problem occurred, what would be the result and what would be the best behavior to counter the problem” was the fact that water came over the decks and filled one compartment after another through the tops of the compartments. This eventually caused the sinking of the Titanic and could have been avoided had the design team been directed to consider that possibility, and designed the compartments such that they went to the top of the ship.

Another design catastrophe was the design of computers in the 60's which did not contemplate what would happen at the end of the century, due to the year date field being represented with only 2 digits. As a result, the system could not discern between 1902 and 2002. The commercial and the military expenditures to correct the system before the turn of the century was monumental, with the problem capable of being recognized had the design team considered what would happen if an error were to occur in the year field during the initial design phase in the 60's and beyond.

In short, there has not been a systematic way of either generating more complete specifications or in analyzing specifications to ascertain the level of understanding necessary to build the appropriate product.

For instance, if the particular function or the product is to be able to “direction find” one has to ask at the very outset “direction find what”. This is followed by the question “how well does one want to find the direction of what”, “how fast”, “how often”, “how many times”, “to what accuracy”, “under what constraints”, and “how much is the entire system to cost”. There is also question as to what priority or rank each requirement should have and what testing or de-bugging is necessary within the product itself.

Thus for instance, if one wishes to direction find on incoming radio signals, one has to ask, what is the object of specifying such a direction finding system. In this case the object is to be able to locate the source of an RF Signal such as from a cell phone. The question then becomes what is the function or property of the system, in other words, what is it to do. In this case, it would be to provide, as an output, the location of the source of the RF Signal. One would then proceed to ask what happens if there is an error in the direction finding apparatus itself and if so, how does the system inform the user that an error has taken place. There are also obvious questions of when to do something and where to do the particular function as well as how fast the function needs to be done, how often is it supposed to be done in terms of number of times per unit of time, which is periodic or how many functions should be performed, meaning how many times per unit of time in an a periodic sense.

For instance in the aforementioned direction finding scenario, if one did not specify for instance, that the accuracy should be within 5 meters, and that it was important for the mission that such be established, then a design engineer could be left to his own devices to decide what the particular accuracies would be. If he or she mis-guessed as to what it should be for the particular scenario, then the system could be designed to a completely different and potentially non-effective system performance for the particular application.

It is common knowledge that when specifying the requirements in the initial design step one commits to the majority of the total life cycle cost for the project long before it is ever spent. This being the case, it is exceptionally important to be able to completely specify what one wants the product to be. The design team then will simply design to that set of requirements.

In order to properly provide a specification one has to ascertain when is a function sufficiently specified and when is it sufficiently defined.

One could ask the question is it sufficiently specified just by specifying the function itself For instance, if the function is provide a GPS locator system, what if anything has been specified, much less completely specified, just by making that utterance. It will be apparent that just by having a wish or desire of something to be done specifies very little in terms of what characteristics it should have, how it should operate, what happens when it doesn't operate and what happens when it doesn't operate properly.

As will be appreciated if one can define a device or product via a function, the function has an input and has an output. Without specifying more one does not have any kind of an idea of how well the output is to be, meaning, how accurate, how precise, how reliable or how meaningful to the end user.

Moreover, by just specifying the function, one does not specify latency, meaning how fast the function is to be performed. Thus in the GPS example, if the GPS locator system is used for emergency location and the system cannot operate and provide a position within a predetermined period of time then it may be too late for the individual seeking assistance.

For instance in above example, if one has found one's position one minute after the particular occurrence, then what is the necessity of providing subsequent updates. It is now important to ask how often updates are to be generated. For instance, if one is lost in the woods and one has only one data point one can have wandered around the woods for a number of hours without changing the fact that one is lost. This is because the question “how often” or “how many” has not been asked; with the single data point is probably not providing sufficient information for rescue or for the individual to find his or her way out.

One often over looked aspect is when one has a bad input, take for example a satellite dish aiming system in which the antenna is to be aimed in accordance with a certain input. If the input is one in which the input is outside the bounds of operations of the pointing system, then one wonders what the system will do when it gets such an input. In one example, the system drove the antenna at a high slew rate until it was stopped by a hard stop and the antenna broke off from the satellite due to the fact that one did not consider what would happen if an input was outside predetermined acceptable bounds. Moreover, assuming that one did consider that a bad input could occur, but failed to consider how fast one should react to the indication of a bad input, then untoward results can occur nonetheless. For instance in the above example, if it is recognized that a bad input is causing the antenna to move outside of its bounds, but the reaction to, for instance shutting down the motors is too long, it is possible that the antenna may nonetheless snap off when it hits the stops.

As another example, if for instance a power supply is overheating, if the system does not react sufficiently quickly to remove the load from the power supply to prevent overheating, then the power supply may in fact self-destruct, as would be the case in some power supply designs. Assuming for instance that the power supply caught on fire then the entire system would be in jeopardy for failure to take into account how fast a bad input needs to be recognized.

One could also subcategorize bad inputs into inputs which are bad from an external source, and inputs which are bad from an internal point of view. For instance, a CPU may have its hard drive go bad which would in turn generate certain inputs that if left uncorrected could result in either other input errors or other undesirable performance attributes.

What will be appreciated is that the generation of a specification is a complicated matter which requires prompting in order to be able for an individual to consider those questions, the answers to which would result in a more highly defined complete better specification. The result of the considering of these questions is that the design team will have a better understanding of what the product is to achieve.

In short, while there may be two engineering functions, one of specifying that which is to be delivered and the other delivering that which is specified, it is desirable to provide a system which generates more complete specifications so that what is delivered is what is desired. In order for this to happen, the system must be completely understood by the engineer who is supposed to build the system. Making sure that engineers have the proper tools to generate complete and understandable specifications is highly desirable.

### SUMMARY OF INVETION

Rather than the design of a system being haphazard and at the whim of the particular engineers assigned to develop a specification, in the subject method, a series of questions are to be asked for each function that the system is to provide. For instance, if there is only one function to be performed then a complete set of questions of who, what, what if error, when, where, how fast, how often, how many, how well, under what constraints, how much, priority or rank, internal test requirements and why provides a set of questions which if asked and answered in the specification for each system function will provide a more complete specification for the function. The result is a reduction of misunderstandings and misinterpretations that could otherwise lead to cost overruns and performance shortfalls.

It will be appreciated that functions aside in every endeavor certain categories of requirements are involved. If questions are applied to each of these categories, the result is a better definition of what is required in the product for that category. Categories can for instance be architectural, behavioral, constraints, deployment, design to cost, environmental, external interface, functional, hardware interface, reliability, affordability, maintainability, availability, supportability, interface requirements, integration and test, logistics, manufacturing and production, performance, priority, software interface, verification and validation, and workmanship. While the above is not an exhaustive list of categories, and not all categories are necessary for each type of specification, the idea is that questions are to be asked relative to categories as well as functions.

The consideration of categories in the final product is important to for instance determine environmental constraints such as whether or not the particular device is going to be exposed to rain or not. Another category, logistics, may include if the device is to be battery operated. If so, the ease of being able to replace batteries may be important. In terms of workmanship, one may wish to specify that the product have no hard edges which could cut an individual.

Of course for each of the categories one can ask a variety of questions at least one pertaining to whether it is a necessary category at all. Plus, in terms of workmanship, if a product that is supposed to fly in space unattended by humans, then whether or not it has sharp edges could be irrelevant. However, if the sharp edge is internal to a satellite, it may be cutting a critical cable, whereas if it is outside of the satellite it has less of an effect on the overall operation of the satellite. It may of course affect an astronaut repairing the satellite from the outside which, for instance, could result in a cut glove or space suit tear. It is not so much that there are answers to the questions involved but that the questions are in fact asked first, considered, and then overtly the specifying engineer chooses to include or not include specification wording to clearly state what is required of the product.

It is therefore part of the subject invention that for each function and for each category considered there are a series of questions that are asked in terms of prompts to the engineer who is writing the specification.

In order to automate the process and indeed to force the engineer to consider the questions, it is part of the subject invention that the questions are provided at a computer screen and are presented to the engineer in terms of fields that the engineer must fill out in order to successfully complete a design project. In this way, in order to complete the project, the engineer is forced to at least enter something into the fields, which will mean that the engineer has, at least to a certain extent, considered the particular question.

It will be appreciated that as long as one can specify a function, the set of questions to be asked should be applied as a method of prompting the individual. For instance a function, which is very broad and global, can have the questions addressed to it, whereas, if the implementation of the global function requires a number of other sub functions, the questions can be applied to them as well.

In summary, a method is provided to prompt an engineer to more completely specify the product desired so as to avoid misinterpretation and misunderstanding leading to improper design and improper product outcome downstream. The result is a disciplined methodology for use in requirements analysis, assessment and specification generation. In one embodiment, the individual generating the specification is instructed to consider a series of questions that relate to the particular function and its behavior, as well as the and performance characteristics of the final device, also including questions relating to cost, priority of the requirement itself and any internal integration and test functions. In addition to the questions, categories of requirements are also utilized depending on the specification to be generated. The result of considering a pre-selected set of questions coupled with a pre-selected set of categories is that a more complete and better understanding of the project from both the product developer and the product specified can be obtained. This method can be utilized both in the generation of the specification and in the analysis of any specification presented to a product developer so that any ambiguities or questions can be identified at the start of the project as opposed to being identified after the project is midway or close to completion.

Since typically a large percentage of the specification and overall project cost and specification is committed to ahead of time, it is important to have a specification, which addresses the wide range of questions that need to be addressed prior to embarking on the program itself. The resultant ability to minimize or eliminate misinterpretations and misunderstandings through posing and answering questions for each function or category results in downstream savings, since one initial mistake is much more expensive to repair downstream than it is catching it at the onset.

### BRIEF DESCRIPTION OF THE DRAWINGS

These and other features of the subject invention will be better understood in connection with the Detailed Description in conjunction with the Drawings, of which:

FIG. 1 is a flow chart of the design methodology utilized assuring completeness and specificity of a specification;

FIGS. 2A and 2B are flow charts illustrating a function divided into sub functions, each of which is made more complete through the utilization of the completeness module of FIG. 1;

FIG. 3 is a table of questions utilized in the completeness module of FIG. 1;

FIG. 4 is a table of the categories of requirements for use in the completeness module of FIG. 1;

FIG. 5 is a chart showing a particular function and qualities or characteristics of the function which are to be analyzed in order to provide a specification that is sufficiently specified and completely defined;

FIG. 6 is a chart of an example of a project to specify a software function to determine the distance to an object; and;

FIGS. 7 and 8 constitute a flow chart in block form showing the application of the subject system to the project of FIG. 6 illustrating the question flow to generate the appropriate completeness prompts.

### DETAILED DESCRIPTION

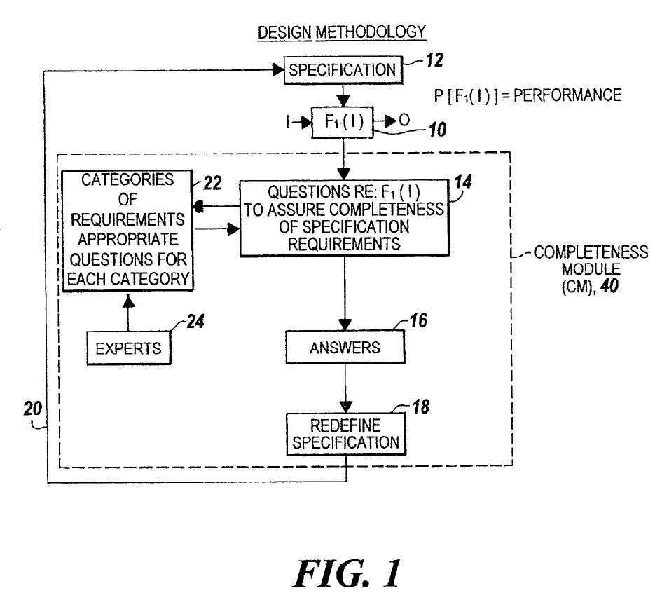

Referring now to FIG. 1, a method and system is portrayed for providing prompts for engineers and other individuals in order to make a specification clear and more importantly to be able to consider all of the things which ought to be considered in generating a complete specification. Rather than a haphazard design process, in the subject invention certain targeted questions are asked given a predetermined function to assure the completeness of the specification which defines the function. As can be seen, a function f₁ 10 is defined by specification 12, with the function having an input I and an output O in which the output reflects the performance expected upon the function operating on the input.

As mentioned, if the function is a broad function, such as a desired result, then merely specifying a desired result does little to address the question of the completeness of the specification.

### Baseline Set of Questions

It is part of the subject invention that a structured set of questions 14 are asked in order to make sure that the specification of the function is complete, with the specification involving requirements that must be met for a complete highly defined specification. The answers 16 derived from questions 14 results in a redefined specification 18. It will be appreciated as can be seen by feedback loop 20 that the process may be an iterative one if the answers to the questions are still unclear or result in a new function requiring specification.

The questions themselves fall into two categories. The first category relates to those which apply to all functions, whereas the second category relates to categories of requirements 22 for a particular task. Depending on the category of the task involved in the function, questions 14 can be augmented or redefined so that answer 16 will be of higher quality representing more completeness for the task at hand. In order for the categories of requirements to be meaningful, experts 24 contribute to the generation of appropriate questions for each category for doing the task.

It will be appreciated that for a given task there are a number of experts whose inputs are useful in defining questions 14 or augmenting them. Thus for a given task or function, there are certain necessary categories of requirements in order to generate a complete specification.

Whether or not one goes to categories, there is a base line set of questions which, when addressed, results in a more complete specification, with more highly defined definitions. Note that any task may be determined as a series of functions F₁, F₂, F₃ . . .

It may be that each top-level function, F₁, F₂, F₃ may be broken up into a series of sub-functions, where a top-level function is comprised into two or more lower level functions. Alternatively, there may be no tiering at all. Rather the sub functions may be made complete irrespective of a higher-level function. Regardless, no matter where the function exists, or at what level, it is important that the engineer be prompted to ask questions of the particular function.

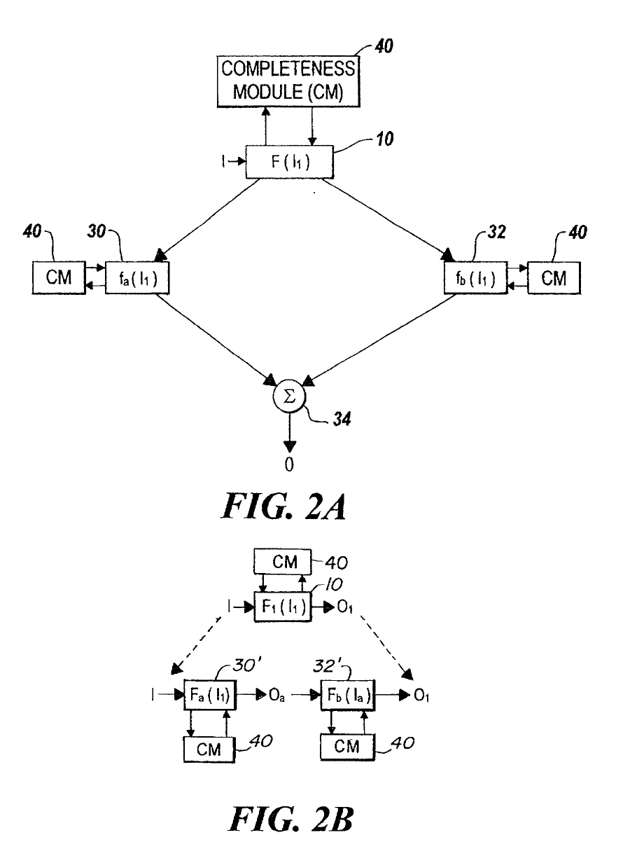

Referring to FIG. 2A, it will be seen that for a given project for a given function, F₁, here illustrated at 10, there may be associated sub functions fₐ 30 and f_{b} 32, each of which needs to be complete to complete the task. The result of asking a structured set of questions for each sub function makes each sub function more complete. The complete specification which combines the results of the prompts is shown at 34.

Referring to FIG. 2B, if there is a necessary hierarchy for the function and the sub functions, the process first assumes that the higher-level function has been well specified by the prompts of CM 10 of FIG. 1.

If the top level function can be decomposed into two or more lower-level functions 30′ and 32′, then for each of the lower level functions the completeness method is applied, yielding a more complete and thus better understood set of requirements for each of the lower level sub-functions.

Thus, for instance, if F₁(I₁) can be broken down into Fₐ and F_{b}, and further assuming that the output of Fₐ is the input to F_{b}, then a better performance result, 0₁, is obtained than if merely asking the appropriate set of questions of F₁(Iₗ).

Regardless of the relationship of the functions, it is nonetheless important to use the completeness method for each separate function.

The completeness module here shown at 40 is that which is contained within the dotted line of FIG. 1. It will thus be seen that for each of the functions or sub functions, the requirements set for each of the functions or sub functions is subjected to intense scrutiny due to the prompts associated with a structured question set designed to assure completeness of the function.

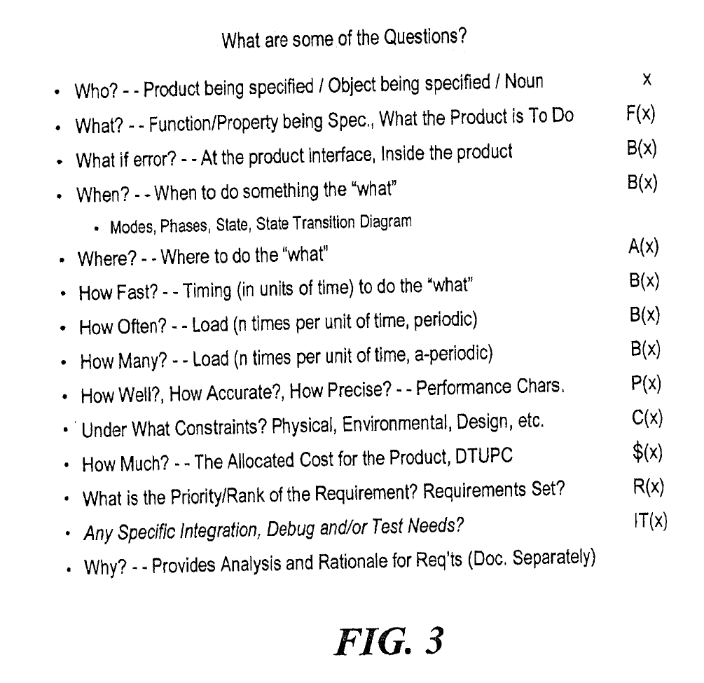

Referring now to FIG. 3, the following general baseline set of questions are intended to ensure through their consideration, the completeness of a specification both as to the number of things considered and as to the preciseness of the definitions involved.

The first of these questions is “who?”. This relates to the product being specified or the object being specified and in general is specified by a noun.

The “what?” question relates to the function or property being specified as to what the product is to do. This is designated by F(x).

One of the problems with generating specifications is the problem of what occurs or is to occur if there is an error. Thus the question “what if error?” relates to errors that occur at the product interface, and inside the product. This is a behavioral question and one that must be addressed such that, being a behavioral question, is given the nomenclature B(x).

The next question, which must be asked, is “when?” which refers to when to do something the “what” specifies. This means one must analyze for each “what” the modes, phases, states, and even state transition diagrams associated with the “what”. It is very important that one know when certain things are to occur based on the “what” function. This is also a behavioral aspect and is referred to as B(x).

A corollary question “where?” is where to do the “what”. Where the functions are to be performed oftentimes has to do with what facility the “what” is to be done at and relates in general to architectural questions given a nomenclature A(x).

A corollary question “how fast?” relates to the timing in units of time to do the “what.” Again, this is a behavioral question and defines the constraints on how fast the function must be executed.

Not only must the speed of the performance of the task of the function be specified, there are two further questions of “how often?” and “how many?” must be answered. This has to do with load factors in terms of the numbers of times per unit time that the function must be performed either in a periodic sense or in a periodic sense.

Of great importance is the question “how well?”, “how accurate?”, “how precise?” must be the results of performing the function, the “what”. These are performance characteristics and are generally designated by the nomenclature P(x).

Not only must the performance characteristics be defined for any function, the “under what constraints” is a question which is oftentimes overlooked. Thus there may be physical, environmental, or design constraints which must be met for the particular function to be completely specified. Here the nomenclature is C(x).

Overall, the question “how much?” is obviously important for the allocated cost for the products. This is designated by the character $(x) and is applied to make sure what is being designed is within cost constraints.

Also an important question is “what is the priority/rank or the requirement?”. In any design specification, the priority of the particular requirement if high, must be recognized, and if at a low level must likewise be recognized. This permits obvious scheduling of tasks to be performed and is oftentimes a question not asked initially in a specification generating session.

A further question “any specific integration, debug and or test needs?” is a question which if addressed early on can result in reformulating the design specification to be able to accommodate indicated needs. This is referred to by nomenclature IT(x) and pulls in a vast array of considerations so that all parts of the finally designed system run smoothly with each other and are easily debugged and tested.

A subsidiary question and a quite general question which should be asked of each function, is “why?”. This prompt provides for the analysis and rational for each of the requirements and may be documented separately. It is used by management to be able to justify the task at hand and to justify the requirements to make sure that the specification is complete.

The above listing of generalized questions are those questions which if not addressed for each function of the project or system can result in oversights which are costly downstream. It is therefore the purpose of asking this generalized set of questions to provide prompts to engineers or others responsible for generating a specification to make sure not only that the specification is complete and that all of the general concerns are addressed in the creation of the specification but also that the definitions of each of the functions and the requirements are rescruitinized to make sure that the specification answers these broad questions.

If these questions are applied to each of the functions and sub functions of the product or task at hand, then the resulting specification created will be more complete than if engineers or specification generating personnel do not consider the aspects posed by the questions.

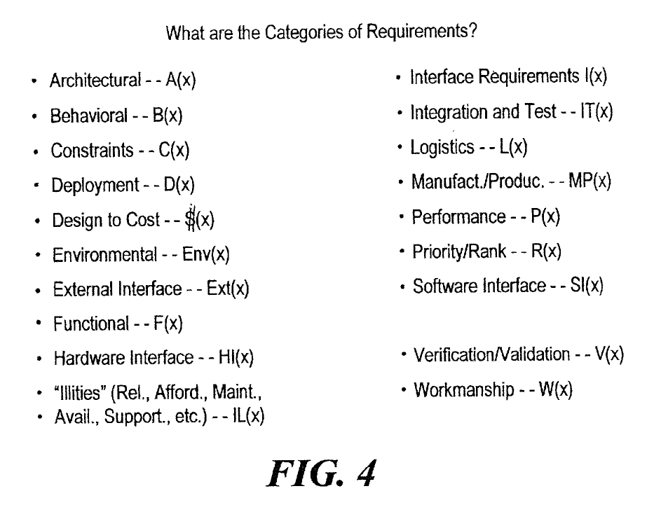

Referring to FIG. 4, for a given task there are usually a set of categories of requirements which must be addressed in order for the specification to be complete and highly defined.

Categories can include architectural, A(x); behavioral, B(x); constraints, C(x); deployment, D(x); design to cost, $(x); environmental, E(x); external interface, EXT(x); functional, F(x); hardware interface, HI(x); Illities which relate to reliability, affordability, maintainability, availability, and supportability, IL(x); interface requirements, I(x); integration and test, IT(x); manufacturing and production, MP(x); performance P(x); priority/rank, R(x); software interface, SI(x); verification/validation, V(x); and workmanship, W(x).

It will be appreciated that the general questions noted in FIG. 3 can be driven by the categories or requirements of FIG. 4, with the categories applied being those considered important by the experts of FIG. 1. Thus the generalized questions of FIG. 3 are to be asked for any function, whereas the categories of requirements of FIG. 4 suggest additional questions which lead to the completeness of a specification in all other aspects of the document.

The result of the application of the questions as prompts to engineers is for the purpose of determining when a function is sufficiently specified and completely defined.

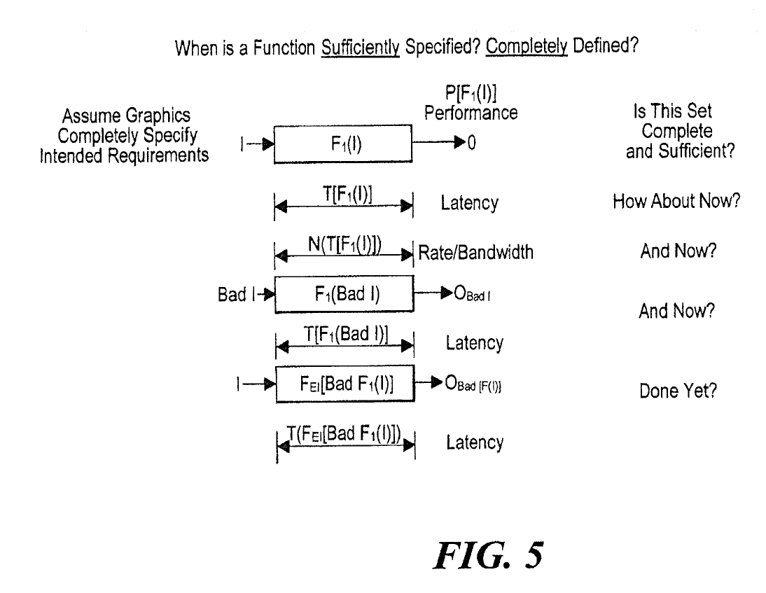

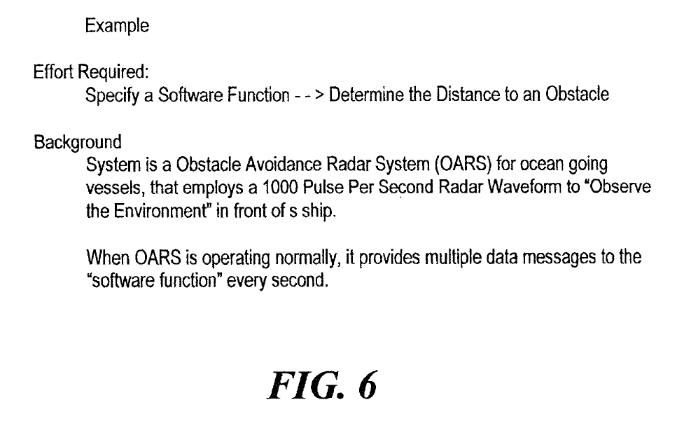

This can be seen by way of example in the chart of FIG. 5.

Assuming that the function completely specifies the intended requirements such that for a given input a specific performance is required, then the question about “how fast?” is asked for the function F1(I) and refers to latency as well as rate/bandwidth for the particular function. For a given function, it is always important to specify how soon the function is to be completed and for the most part, how often it is to be completed assuming such is appropriate.

It is also important to consider what happens if the input is unexpected or “bad”. Therefore, it is important to be able to specify a sub function of what happens when an input is bad and to provide a latency figure to determine if the input is bad, how fast one must execute the required response.

One of the more important things to probably ask is, whether or not the input is bad and what is to be done about it because it is usually assumed that for a given function the inputs are known and are stable. Considering what happens if they are not, it is indeed as important to what the system or product is supposed to do when the inputs are in fact bad, regardless of the cause.

What is therefore provided is a methodology for design engineers to assure a much higher degree of completeness of a specification and the specificity of the definitions used in the specification through the utilization of a series of questions resulting in prompts which will guide the design engineer or the individual generating the specification to make it completely clear and to assure that it is indeed complete.

The subject system may be utilized not only in the design generation phase in which the specification is completed, it can also be utilized to understand and or correct the specification of others. Oftentimes, it is the case that a specification is generated by one entity for quote by another entity. Asking these questions of the specification provided results in clarifications of misunderstandings and inaccuracies prior to the time that the quoting process is completed. Moreover, illuminating misunderstandings at this early juncture, even for an already quoted project, can result in considerable savings downstream due to the catching of errors and inconsistencies at an early stage.

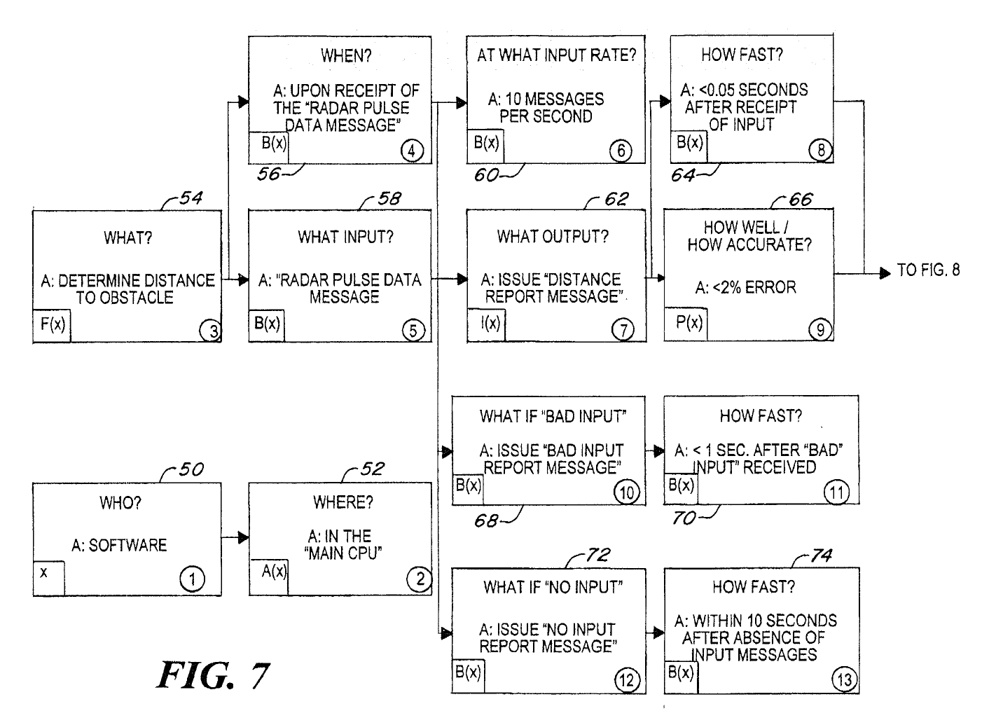

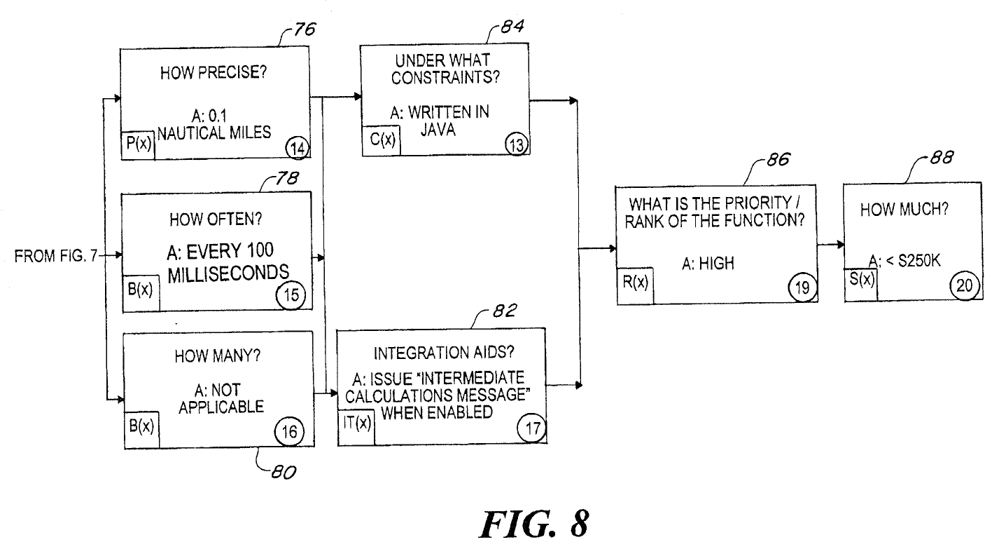

Referring now to FIGS. 7 and 8, what is provided is an example of the utilization of the completeness module as depicted in FIGS. 1 and 2 to a specific problem of for instance, determining the distance to an obstacle. Each of the boxes within these figures represents a Completeness Module Question being posed to assist the team in understanding and then specifying the requirements for particular function in this case, “Determine Distance to an Obstacle”. The result of the application of the question is a more complete and likely easier to understand set of requirements describing that which is required of the product providing the “Determine Distance to an Obstacle” function.

Referring to each process step the term reference identifies the completeness module process step being discussed. The question for each box identifies the question being posed using the completeness module. The category identifies a category that the question is related to. The symbol in the lower left corner of each of the boxes identifies a short hand mathematical symbol for the completeness module question/category step being discussed. The purpose provides a summary of the purpose for posing the question, whereas the answer provides the answer to the question posed for the example “Determine Distance to an Obstacle”. Finally, possible ramifications identify possible issues and problems that may arise if the question being posed is left unasked and unanswered.

Referring to the first of the boxes, namely box #1 here given reference character 50, the question “who?” or what product is to be provided that will contain the necessary and required functions and capabilities is indicated in the box. Category is not applicable in this particular box, whereas the symbol is “x” and the purpose is to provide the design team the identity of the product to be provided. The answer in this case is “software” and the possible ramifications is a topic that is generally not an issue regarding the product to be provided.

As to box 52, the question “where?” is where is the product to be provided within the system architecture. The category is “architectural”, the symbol is A(x). The purpose is to determine if the function being specified for the product is to be assigned to a specific product element or not, with the answer being “in the main central processing unit or CPU”. The ramifications possible are if the function is to be performed within a specific architectural element, and is not specified as such, the design team working to provide the functionality required may not understand this intention. As a result, the design team may inadvertently design the product for another element of the system, costing the program valuable resources both financial and schedule related, when the mistake is finally uncovered. Thus the question of possible ramifications must be asked at box 52.

At box 54, the question is “what?” which is what function is being specified for the product. The category is “functional”, the symbol is F(x) and the purpose is to provide the design team the identity of the function being specified for the product. The answer is “determine distance to obstacle” and the possible ramifications are as follows: Usually the function for the product is specified or identified by name. Where the function is adequately and completely specified is another subject altogether. By itself, the name of the function is usually not sufficient to completely specify it. The combination of answering the completeness module's questions regarding the various categories, e.g. input, output, performance, behavior, will provide definitive definition of the function, leading to a more complete specification and thus minimizing possible misunderstandings and misinterpretations. For example, stating that the function to be provided is “sort list names”, this identifies the function, but without specifically defining and identifying the type of list or input to sorted. Moreover, what is not specifically provided is how specifically the sorted list is to be presented as an output and what defines the sort function itself, namely the performance, where the sorted list for instance would be required to be in “ascending order” or “descending order”.

As can be seen in box 56, question “when?” means when is the function specified to be executed. The category is a “behavioral” category and the symbol used is B(x), with the purpose to provide the design team an indication of when the function is to be executed. The answer is “upon receipt of the radar pulse data message”, with the possible ramifications being that the answer to this question may provide one or more independent conditions of when the function is to be executed. Without identifying these conditions, the design team will be missing key insights as to when the start of the function is to occur, whether the function is continually running or not. All of this may lead to poor design choices and could eventually cause system level problems that would require additional time and financial resources to correct later.

Referring to box 58, the question posed is “what input?” this relates to the inputs to be provided to the question being specified. The category is “interface requirements”, with subsets including software interface, and hardware interface, with the symbol being I(x) and the purpose is to identify the input that the function will operate upon. Note, more than one input may be identified in answering this question. The answer is “radar pulse data message”. This includes the definitive specification of input parameters contained within this message and each parameter's range, low to high acceptable values, resolution, and type of unit that the parameter is represented in. The possible ramifications are that without identifying in specific detail the input provided to the function, and the various attributes of each parameter within the input, the design team will be handicapped in understanding what information the function will have at its disposal in order to perform the necessary work to produce the desired output.

Referring to box 60, the question is “at what input rate?” which means how fast the input needs to be provided to the function. The category is “behavioral”, the symbol is B(x) and the purpose is to identify to the design team, the rate at which each input will be provided to the function. Note that it is not required that each input be represented to the function at the same rate, or at the same time. Understanding this aspect is important regarding producing a design that is sufficient and adequate to meet the necessary performance required for the function. The answer “Ten messages per second” is specific enough, with the possible ramifications being that by not understanding the rate at which the input will be provided to the function, the designer may implement design choices that render the product less than fully successful, or the product design may become overly complex and expensive to handle input conditions that are not warranted. For example, in the first case, assume that the input rate to be handled is actually a hundred times per second, but the design team is not aware of these conditions and assumes a much lower input rate. The result could be a product that is overwhelmed by the actual input rate, and several undesired resulting product behaviors may result. In the second case, where the assumed rate was much higher than the intended and expected rate, the actual design and implementation could be more than sufficient to handle the rate. However, the cost of such an overly designed product in terms of both time to market and dollars to produce may result in a product that is less desirable to the consumer's downstream.

Referring to box 62, the question “what output?” refers to what is the output that the function is to provide. The category is “interface requirements” and the symbol is I(x), with the purpose to identify the output that the function is required to provide. More than one output may be identified in answering this question. The answer is “distance report message”. This includes a definitive specification of the output parameters contained within this message and each parameter's range, resolution and type of unit that the parameter is represented in. The possible ramifications are that without identifying in specific detail the necessary and required output to be produced by the function, the design team is not provided key insight as to the specific definition of the function. As such, the design team may choose an implementation that is perhaps either insufficient or incomplete, or instead they may choose to implement an overly complex product. In either case, the program team as a whole has assumed additional risk and perhaps additional cost by this lack of specification information.

Referring to box 64 the question posed is “how fast?” which is how fast is the output to be provided by the function once the input is received by the function. The category is “behavioral” and the symbol is B(x). Its purpose is to identify to the design team, the longest acceptable time line during which the function must be performed after receipt of the input. By so doing, the design team is provided with an understanding as to the nature and urgency that the function must operate within. The answer “less than 0.05 seconds after receipt of the input”. Thus, the radar pulse data message indicates how fast the system must operate. The possible ramifications include that without understanding this performance timeline aspect, the design team may produce a product that is functionally correct which produces the proper output but is behaviorally inadequate so as to render the product as a whole to be essentially worthless to the system and to the end consumer. Costly re-design and re-development will likely occur in order to correct for this time line deficiency.

Referring to box 66, the question asked is “how well/how accurate?” which is what is the expected minimum quality level of the output to be produced by the function. The category is “performance” and its symbol is P(x) whose purpose is to identify the minimum required output performance for the product. The answer is “less than 2% error” and the possible ramifications are as follows. Not understanding the expected minimum quality level can lead the design team to produce a product that is not useful to the system or to the consumer. Costly re-design and re-work may result. For example, if the product produced was a simple digital weighting device, but the error tolerance (output performance) of the device were not specified, two possible scenarios may result. In one scenario, the design team may choose to implement a design that has an error of no more than one pound, when in fact the required performance may be more stringent, on the order of one ounce instead. This would result in the customer being dissatisfied with the performance of the product. In another scenario, the design team may assume a very challenging performance requirement of an error no more than 1/10th of an ounce, producing a very expensive product, when the actual required minimum performance might only have an error of not more than one pound, resulting in a product that is too expensive for its intended use.

Referring now to box 68, the question is “what if bad input?” which is what should the product do a bad input is received by the product. The category is “behavioral”, and the symbol is B(x). The purpose is to provide the design team with explicit specification guidance in how the product is to react to an improper input it has received. The answer in one case, is “issue bad input report message”. The possible ramifications are that not handling a bad input can lead to an innumerable set of outcomes some of which may be innocuous in nature, others very severe and all depending the severity of the bad input and the severity of the product reaction to the bad input it has received. By not specifying how a product is to handle a bad input, the specifying team and eventually the end system and the end users are taking the risk of not knowing how the product will actually perform under those types of conditions. For example, assume the product was to supply accurate chemical analysis of a blood sample in order to determine red and white blood cell counts within the sample. Assume that the volume of the sample was an important input condition in order for the product to perform an accurate assessment, and the valid operating range for that input parameter is from 10 to 100 CCs. By not specifying what the product should do in the event that the input value provided to the product was outside the valid 10-100 CCs range, untold performance outcomes may result, leading to perhaps inappropriate conclusions and reactions to the output results provided by the product.

Referring to box 70, the question is “how fast?” which is how fast is the output to be provided by the function once the input is received by the function. The category is “behavioral” and the symbol is B(x). The purpose is to identify to the design team, the longest acceptable time line during which the function must be performed after receipt of the input condition, in this case a bad input which has been received provided to the product. By so doing providing the design team with the understanding as to the nature and urgency that the function must operate within is critical. The answer “less than one second after the bad input was received” answers the question. The possible ramifications are that once determined that the product has a non-deterministic behavior, meaning that because a deterministic behavior was not specified to handle the various possible set of bad input conditions, when presented with bad input conditions, the value and usefulness of the product will likely diminish. This may lead to possible loss of sales and revenue and costly re-work and repair to correct the deficiencies within the product and is a likely outcome if the bad input message is not quickly provided. This leads to possible loss of sales and revenue and costly re-work and repair to correct the deficiencies within the product. Furthermore, if some of these non-deterministic results occur, system safety or personal safety issues can substantially impact the company and the sponsors that produce the product.

Referring to box 72, the question is “what if no input is received?” meaning what if no input is received for an extended period of time. The category is “behavioral”, and the symbol is B(x). The purpose is to identify to the design team the required behavior if the absence of input for an extended period of time occurs, and that this is not an acceptable condition for the system. The answer is to issue a no-input report message. As to the possible ramifications if a no input condition is a problem for the system, and there is no specified behavior that the product is required to produce when the condition exists, then the system or its users may assume that the system is in good working order when that is not the case and the system or the system's users may execute decisions based on this false premise. Depending on the type of “no input conditions” safety issues to both the system and or the end users may result. For example, a nuclear reactor, not having sufficient water flow to cool the nuclear rods will likely result in a hazardous condition unless detected and reported before the issue reaches uncontrollable conditions.

As illustrated at box 74, the question is “how fast?” which means how fast is the output to be provided by the function once the input is received by the function. The category is “behavioral” and the symbol is B(x). The purpose is to identify to the design team, the longest acceptable time line during which the function must be performed after the detection of a no-reception of input for an extended period of time. By doing so, providing the design team with the understanding as to the nature and urgency that the function must operate within is critical. The answer in this case, is “within 10 seconds after the absence of any input messages.” The possible ramifications as discussed above are that producing the correct result is not always sufficient when the time line of the result matters. In the case of the nuclear reactor losing water-flow mentioned above, rapid detection and indication of the loss of flow is critical. Without specifying the minimal reaction time required by the product, the specifying team is taking a risk as to how the end product will perform and whether that performance is sufficient or not.

Referring now to FIG. 8 and continuing with the flow chart, as illustrated in box 76, the question posed is “how precise?” meaning to what minimum precision will the output parameters be quantified. The category is Performance and the symbol is P(x). The purpose is to indicate to the design team the minimum required precision that the output parameter will be required to achieve within the product. The answer in this case is, “0.1 nautical miles”. The possible ramifications are that without stating the required minimum precision, the design team may choose to implement algorithms and or heuristics that produce an otherwise acceptable output result but not to the minimum level of precision required by downstream system elements. This could lead to compounded errors building up in the overall system. For instance, without this item being specified, the design team may produce a product that determines the distance to objects to be quantified to a level of 10 nautical miles. In this case, the product is functionally producing an appropriate output, but with insufficient performance to meet overall needs.

Referring now to box 78, the question is “how often?” which is how often is the product to execute the required functionality. The category is “behavioral”, the symbol is B(x) and the purpose is to identify the minimum number of units of work per unit time, the load, that the product is required to achieve in order to meet the systems needs. This question is appropriate when the load on the product is periodic and regular. In the “determine distance to an obstacle” example, since the input rate's response was ten times per second, the specifying team has not yet indicated whether each input is 100 milliseconds apart, thus also periodic. Moreover, it is not indicated that the input can come in bursts, totaling ten input messages per second and thus is aperiodic in nature. Providing that insight as to whether the input in the load is periodic or aperiodic is an input item for the design team to consider when they are designing and then implementing the product itself. The answer “every 100 milliseconds” poses the question that since the “how often” question is tied to a periodic input/output response, a more complete answer to the “at what input rate” should have been every 100 milliseconds as well. Thus by prompting the specifying team to consider whether the products behavior is to be periodic in nature or not, the completeness module provides a means to perform cross checks to minimize possible inadequate specifications and thus reduce down stream misunderstandings by the design team. The possible ramifications are that without an understanding of the load on the product, the design team may produce and end product that either consumes too much of a resource, in this case CPU cycles per each execution of the product per each input message received, and thus is not able to process the ten periodic messages per second required of it. Or the product may be overly designed to handle 1000 messages per second, for example, and thus add additional costs and risks to the product's development.

Referring now to block 80, the question is “how many?” This means how many times per unit time is the product to execute the required functionality. The category is behavioral and the symbol is B(x). The purpose is to identify the minimum number of units of work per unit time or the load that the product is required to achieve in order to meet the system's needs. This question is appropriate when the load on the product is aperiodic and thus not regular. In the “determined distance to an obstacle” example, since the input rate response was ten times per second, the specifying team has not yet indicated whether this is aperiodic in nature. Providing that insight, whether the input and the load is aperiodic or periodic, it is input data for the design team to consider when they are designing and then implementing the product itself. The answer in this case is “not applicable”. By stating that the answer to the question is not applicable, the specifying team is further emphasizing that the nature of the input rate is periodic. The possible ramifications are that assuming that the actual input rate was aperiodic in nature, and the specifying team does not specify that condition and hence inform the design team, the design team's implementation may not be suitable to handle the expected input conditions. For the obstacle example, the design team may in this case assume that it has 100 milliseconds of processing time line to perform the entire function from receipt of an input to production of the output, when that probably would be an erroneous assumption, This would lead, perhaps, to insufficient performance from product. Note the response to the “how fast” question also provides a cross check that indicates to the design team that it only has 50 milliseconds to produce the required output after the receipt of an input message.

Referring to box 82, the question is “integration aides?” meaning what capabilities will need to exist within the product itself in order to be able integrate and test the product within the system. The category is “integration and test” and the symbol is IT(x). The purpose is to identify additional features and capabilities that the product must provide in order to facilitate downstream integration and testing activities, where the cost and schedule impacts of not having these particular features and capabilities may exceed the cost of including them into the product design from the start. The answer is “issue intermediate calculations messages when enabled”. The possible ramifications are that during integration and testing activities when the system's performance is not yet at the required levels, the ability for the product team to understand if certain elements of the system are or are not meeting their explicitly required levels of performance can help to isolate where problems exist within the system. Not having these features and capabilities would extend the amount of time and resources required by the product team in determining where problems exist within the system and then implementing solutions to correct the problems. Note, IT(x) features and capabilities are also valuable tools in understanding what system problems exist in a fielded system as well as a system going through its initial system build up integration and test phase.

Referring to box 84, the question is “under what constraints?” which means what are the pertinent design constraints that must be taken into account by the design team. The category is “constraints” and symbol is C(x). To indicate to the design team a set of design constraints exists that the product must conform to. For example, on many occasions a design of a software product may be constrained to a certain set of software languages, software operating systems and specific computer types. If the product being specified contains hardware, specifying the what it is maximally allowed to weigh is also a constraint on the product. Here the answer is “written in java” and the possible ramifications are that if the design team failed to identify the necessary and required constraints that a product in the design team must meet in order to peruse the item product, the specifying team is taking on additional risk that the product will need to go through costly rework and redesign when the oversight is discovered downstream, possibly also affecting the overall delivery schedule for the product.

Referring to box 86, the question is “what is the priority/rank of the function?” the category is “priority/rank” and the symbol is R(x). The purpose is to indicate the relative importance of the function within the product in relation to other functions that the product is specified to provide. To provide the design team with specific guidance when implementation issues and constraints indicate that a product will not have sufficient capability to execute all functions at the intended rates under all possible scenarios. Thus, understanding which functions are more important than other functions will provide the design team with the guidance as to how to construct a product's behaviors such that the more important functions are to be provided with the resources required. This may be at the expense, hopefully short lived, of the lower ranked items. Possible ramifications are, that the design team's implementation may “starve” a more important function at critical junctures, in order to serve a lower priority function. For example, assume that the higher priority function is to sound an alarm if a temperature sensor input reaches a certain threshold value. If during the execution of a lower priority function, the temperature sensor input reaches a “certain threshold value”, but the software's CPU is being controlled by the lower priority function, the resulting impact to the system could be disastrous due to part of the system eventually overheating and perhaps catching on fire. By indicating relative levels of priority/rank, in this case the design team should consider “interrupt priority schemes or equivalent” such that a higher priority function can step in and take control of the CPU in order to perform its required functionality when events and conditions call for it.

Referring now to box 88, the question is “how much?” and refers to what is the product development cost for the product? What is the target recurring cost for the product? The category is “design to cost” and the symbol is $(x). The purpose is to indicate the level of financial resources allocated to the design team to achieve the end item product, for development, cost, and second for recurring manufacturing of the product cost. The answer is “less than $250,000.00”. Note that since this is a software example, for simplification reasons, a design-to-unit-production-cost or DTUPC answer is not provided. However, if a product contains hardware elements, the completeness module would request that a DTUPC target answer be provided as well. As to possible ramifications, not understanding the financial resources available to design and produce the product can lead to a design team over designing the product to include adding costly “bells and whistles” features that either render the end product too costly for the end consumer, or add development costs to the project team, where financial resources to pay for the overrun may not be available, thus threatening the project with possible default and early termination due to lack of funding.

Having now described a few embodiments of the invention, and some modifications and variations thereto, it should be apparent to those skilled in the art that the foregoing is merely illustrative and not limiting, having been presented by the way of example only. Numerous modifications and other embodiments are within the scope of one of ordinary skill in the art and are contemplated as falling within the scope of the invention as limited only by the appended claims and equivalents thereto.

What is claimed is:

1. A method for prompting individuals in charge of generating a specification for a project to make changes to the specification which will assure completeness of the specification, comprising the steps of:
characterizing the specification into one or more functions;
asking for each of the functions a set of questions, the answers to which are used in referring the specification; and,
refining the specification in accordance with the answers to the questions, whereby the refined specification is more complete.

2. The method of claim 1, wherein the set of questions includes a generalized set of questions.

3. The method of claim 2, wherein the set of generalized questions includes questions to prompt the individuals into considering the ramifications of possible issues and problems that may arise if the question being posed is unasked, or if asked, is unanswered.

4. The method of claim 1, and further including the step of ascertaining the category of a function and framing questions to be asked in the asking step specific to the category.

5. The method of claim 1, wherein the set of questions includes generalized questions includes “Who?” “What?” “What if Error?” “When?” “Where?” “How Fast?” “How Often?” “How Many?” “How Well?” “Under What Constraints?” “How Much?” “What Priority?” and “Any Specific Integration, Debug or Test Needs?”

6. The method of claim 5, wherein all of the questions are asked for completeness.

7. The method of claim 1, wherein the questions include questions related to the category of the function.

8. The method of claim 7, wherein the category related questions include categories of requirements including one or more of architectural, behavioral, constraints, deployment, cost, environmental, interface, ilities, integration and test, logistics, manufacturing and production, verification and workmanship.

9. The method of claim 1, wherein one of the questions is “Why?”
